(19) United States
(12) Patent Application Publication
(10) Pub. No.: US 2024/0096119 A1
(43) Pub. Date: Mar. 21, 2024

(54) Depth Based Image Tagging

(71) Applicant: Synchronoss Technologies, Inc., Bridgewater, NJ (US)

(72) Inventor: Stephen John Heathcote Gurnett, Valenciennes (FR)

(21) Appl. No.: 18/269,475

(22) PCT Filed: Dec. 30, 2021
(86) PCT No.: PCT/US21/65797

§ 371 Date: Jun. 23, 2023

Related U.S. Application Data
(60) Provisional application No. 63/132,133, filed on Dec. 30, 2020.

(51) Int. Cl. G06V 20/70; G06T 7/50; G06T 7/62; G06V 10/46; G06V 10/50; G06V 10/764

(52) U.S. Cl. CPC G06V 20/70; G06T 7/50; G06T 7/62; G06V 10/462; G06V 10/50; G06V 10/764; G06V 2201/07

(57) ABSTRACT

Systems, methods, devices, and non-transitory computer-readable media for depth-based image tag generation are described. The disclosed technology may access images stored in an image repository. The images may comprise a first image. Using image processing techniques, a first object and a second object in the first image may be detected. Using machine-learning models, a first tag associated with the first object and a second tag associated with the second object may be identified. Using the machine-learning models, a first depth value associated with the first object and a second depth value associated with the second object may be determined. Based on the first depth value and the second depth value, a spatial relationship between the first object and the second object may be determined. Metadata associated with the first image may be generated. The metadata may indicate the spatial relationship between the first object and the second object.

### CROSS-REFERENCE TO RELATED APPLICATIONS

This application claims the benefit of priority to U.S. Provisional Application No. 63/132,133, filed Dec. 30, 2020 and entitled “Using Depth/Scale Information to Enrich Image-Based Tagging,” the entirety of which is incorporated by reference herein for all purposes.

### FIELD OF USE

Aspects of the disclosure relate generally to an automated method of tagging images. More specifically, aspects of the disclosure provide for the automatic intake of images in order to determine depth information for objects visible in the images and generate metadata that includes the depth information.

### BACKGROUND

In comparison to searches for textual data, an image search introduces an additional layer of complexity to the search process, since the media being searched does not directly correspond to the search terms. To overcome the hurdles presented by searching images directly, an image search may involve searching through metadata (e.g., tags, tag data) that includes information associated with the content of corresponding images. In some cases, the metadata is the result of the images having been processed using manual or automated image tagging techniques that result in basic information relating to the content of the respective images. When searched, the tagged images that are returned may be relevant (e.g., the content of the search terms is included in the image) but not necessarily useable by the user. For example, a search for a famous landmark, such as a famous building, may result in an image in which the landmark is far in the background of the image or mostly obstructed by some other object in the image.

Furthermore, though the computational resources associated with a small number of searches or a small number of images may not be large, the computational resources expended to perform many searches or search a large database of images may be significant. Further, irrelevant or unusable images may cause users to spend inordinate amounts of time searching and looking through images until an acceptable image is found. In some cases, a user may give up their search or settle for a less relevant image as a result of the burden associated with the manually reviewing images for an image that satisfies the user. More relevant search results might be possible if there were a way to generate tags that more effectively indicate the position of objects within images. As such, there exists a need for images that have richer tags that are more efficiently searchable and more relevant to the search terms.

### SUMMARY

The following summary presents a simplified form of various aspects described herein. This summary is not a comprehensive overview of the subject matter in the detailed description nor does this summary limit the scope of the claims presented herein.

Aspects described herein are generally directed to the generation of metadata that is associated with image data. These aspects may improve the effectiveness with which metadata is generated by offering an automatic method to generate tags based on depth information.

Aspects described herein may allow for automatic methods, systems, apparatuses, and/or non-transitory computer-readable media to generate metadata associated with image data. Through novel implementations of sophisticated data analysis and image processing techniques which may include the use of machine-learning models, the aspects described herein allow for the generation of more relevant metadata that better describes content that is represented in images. The use of such techniques may provide a host of technical effects and/or benefits including the generation of more descriptive metadata that provides information with respect to spatial relations of objects in images. In this way, more relevant search results may be returned due to the more comprehensive metadata that includes indications of the positioning and/or location of objects within an image. According to some aspects, these and other technical effects and benefits may be achieved by automatically generating improved metadata by determining the depths of objects in images using either existing depth information or through use of image processing techniques to detect objects and/or estimate the depth of the objects.

Furthermore, a machine learning model that is trained to detect objects in images and/or estimate the depth of those objects may be used to generate the depth-based metadata. This use of machine-learning models may be implemented by using large datasets including images to train the machine-learning models to detect objects in images and/or estimate the depth of those objects. These datasets may include a combination of images that include metadata and images that do not include metadata. Furthermore, the machine-learning models may be periodically trained using fresh datasets, thereby allowing for improved accuracy of object detection and/or depth estimation that is based on more up to date information.

More particularly, some aspects described herein may provide a computer-implemented method of generating metadata. The method may comprise accessing, by a computing device, a plurality of images stored in an image repository. The plurality of images may comprise a first image. The method may further comprise detecting, using one or more image processing techniques, a first object in the first image and a second object in the first image. The method may further comprise identifying, using one or more machine-learning models, a first tag associated with the first object and a second tag associated with the second object. The method may also comprise determining, using the one or more machine-learning models, a first depth value associated with the first object and a second depth value associated with the second object. The method may further comprise determining, based on the first depth value and the second depth value, a spatial relationship between the first object and the second object. The spatial relationship may comprise the locations of the first object and the second object in the first image. Furthermore, the method may comprise generating metadata associated with the first image. The metadata may indicate the spatial relationship between the first object and the second object. The spatial relationship may indicate a size of the first object relative to the second object.

The first image may comprise a plurality of points and the first depth value and the second depth value are associated with portions of the plurality of points. Further, the plurality of images may comprise one or more videos.

Further, the method may comprise excluding a third object from the metadata based on a determination that the third object occupies less than a threshold amount of the first image. The spatial relationship may indicate that the first object is obstructed by the second object.

The method may comprise excluding a third object from the metadata based on a determination that the third object is obstructed by greater than a threshold amount.

The one or more image processing techniques may comprise at least one of: a scale invariant feature transform (SIFT) technique or a histogram of oriented gradients (HOG) technique. The one or more machine-learning models may comprise one or more convolutional neural networks.

Identifying the first tag associated with the first object and the second tag associated with the second object may further comprise: applying a first label to the first object and a second label to the second object. Further, the method may comprise determining, based on one or more classifications, the first label and the second label; and writing the first label and the second label to the metadata along with the spatial relationship. The one or more classifications may comprise at least one of: a person, an animal, a vehicle, a landmark, a foreground, or a background.

The spatial relationship may indicate that the first object is in a foreground or a background relative to the second object. Further, spatial relationship may indicate one or more proportions of the first image that are occupied by at least one of the first object or the second object.

The method may comprise modifying, by the computing device, the image data based at least in part on the metadata. Modifying the image data may comprise adding one or more portions of the metadata to the image data, deleting one or more portions of the metadata associated with the image data, or adjusting one or more portions of the metadata associated with the image data.

More particularly, some aspects described herein may provide an apparatus comprising: one or more processors; and memory storing instructions that, when executed by the one or more processors, cause the apparatus to: access a plurality of images stored in an image repository. The plurality of images may comprise a first image. The instructions, when executed by the one or more processors, may cause the apparatus to detect, using one or more image processing techniques, a first object in the first image and a second object in the first image. The instructions, when executed by the one or more processors, may cause the apparatus to identify, using one or more machine-learning models, a first tag associated with the first object and a second tag associated with the second object. The instructions, when executed by the one or more processors, may cause the apparatus to determine, using the one or more machine-learning models, a first depth value associated with the first object and a second depth value associated with the second object. The instructions, when executed by the one or more processors, may cause the apparatus to determine, based on the first depth value and the second depth value, a spatial relationship between the first object and the second object. The spatial relationship may comprise the locations of the first object and the second object in the first image. Furthermore, the instructions, when executed by the one or more processors, may cause the apparatus to generate metadata associated with the first image. The metadata may indicate the spatial relationship between the first object and the second object.

More particularly, some aspects described herein may provide one or more non-transitory computer readable media comprising instructions that, when executed by at least one processor, cause a computing device to perform operations comprising accessing, by a computing device, a plurality of images stored in an image repository. The plurality of images may comprise a first image. The operations may further comprise detecting, using one or more image processing techniques, a first object in the first image and a second object in the first image. The operations may further comprise identifying, using one or more machine-learning models, a first tag associated with the first object and a second tag associated with the second object. The operations may also comprise determining, using the one or more machine-learning models, a first depth value associated with the first object and a second depth value associated with the second object. The operations may further comprise determining, based on the first depth value and the second depth value, a spatial relationship between the first object and the second object. The spatial relationship may comprise the locations of the first object and the second object in the first image. Furthermore, the operations may comprise generating metadata associated with the first image. The metadata may indicate the spatial relationship between the first object and the second object.

Corresponding apparatuses, devices, systems, and computer-readable media including non-transitory computer-readable media are also within the scope of the disclosure. These aspects, features, and benefits of various embodiments of the present disclosure along with many others, are discussed in greater detail below.

### BRIEF DESCRIPTION OF THE DRAWINGS

The present disclosure is illustrated by way of example and not limited in the accompanying figures that are referenced by the specification.

FIG. 1 illustrates an example of a computing system that may be used to implement one or more aspects of the disclosure in accordance with one or more illustrative aspects discussed herein.

FIG. 2 illustrates an example of a computing device that may be used to implement one or more aspects of the disclosure in accordance with one or more illustrative aspects discussed herein.

FIG. 3 illustrates an example of a method for generating metadata for images according to one or more aspects of the disclosure.

FIG. 4 illustrates an example of a method for detecting objects in an image according to one or more aspects of the disclosure.

FIG. 5 illustrates an example of an image retrieved based on metadata according to one or more aspects of the disclosure.

FIG. 6 illustrates an example of an image retrieved based on metadata according to one or more aspects of the disclosure.

FIG. 7 illustrates an example of an image retrieved based on metadata according to one or more aspects of the disclosure.

FIG. 8 illustrates an example of an image retrieved based on metadata according to one or more aspects of the disclosure.

Reference numerals that are used in multiple figures are intended to refer to the same or similar features in various embodiments.

### DETAILED DESCRIPTION

In the following detailed description of various embodiments, reference is made to the accompanying drawings, which form a part of the present disclosure, and in which is shown by way of illustration various embodiments in which aspects of the disclosure may be practiced. It is to be understood that other embodiments may be utilized and structural and functional modifications may be made without departing from the scope of the present disclosure. Aspects of the present disclosure allow for other embodiments that may be practiced or carried out in various ways. Also, it is to be understood that the terminology used herein is for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents.

Effective searches may involve a combination of effective search algorithms and effectively organized data. While a set of images may be searched manually by a user, image searches may also be performed on metadata that is associated with the set of images (e.g., metadata that is embedded in an image and/or metadata that is separate from the image). That is, a user may request an image search by entering search terms, which may be used to query a set of images. Images that contain metadata (e.g., tag data) that matches the search terms may be returned in response to the user's search request. As such, the relevance of search results may depend on the amount and/or quality of metadata (e.g., tag data) that describes the content of associated images. For example, a search of images without metadata and/or with sparse metadata (e.g., metadata including only characteristics of the image data without semantic content), may lead to suboptimal search results that are either irrelevant or missing some key feature of the image.

In some cases, the positioning of objects in an image may significantly influence the extent to which an image is useful. For example, a relevant object (e.g., one that matches a user's search terms/query) may be obstructed (e.g., a landmark or person that is obstructed by another object), too small (e.g., an object that is in the background of an image), or not relevant (e.g., an image of a toy car in response to a search for an actual drivable automobile). In another example, metadata (e.g., tag data) may not include depth information associated with each of the one or more objects represented in an image. Instead, the metadata (e.g., tag data) for an image may indicate that certain points of an image are at a certain depth (e.g., a certain distance from the image capture device) without indicating a depth associated with an object. Metadata (e.g., tag data) that does not include information associated with the depth of objects represented in images may result in search results that are not useful, which further results in wasted computing resources (e.g., processor cycles, memory allocations, etc.).

To generate improved metadata (e.g., tag data) and achieve the benefits (e.g., more efficient use of computing resources and improved search results) that may be realized by having more content rich metadata (e.g., tag data), the aspects discussed herein may, for example, use various image processing techniques (e.g., machine-learning models configured and/or trained to detect objects in images) to detect objects in images and determine various spatial relationships between the detected objects. In particular, aspects discussed herein may relate to systems, methods, non-transitory computer readable media, devices, and techniques for generating metadata.

A computing device implementing the disclosed technology may access a plurality of images stored in an image repository. The plurality of images may include a first image. For example, the computing device may access an image repository associated that stores images uploaded by users for public viewing. The computing device may then detect, using one or more image processing techniques a first object and a second object in the first image. For example, the computing device may use a scale invariant feature transform (SIFT) technique to analyze the images and detect objects that are represented in the images. The computing device may then identify, using one or more machine-learning models a first tag associated with the first object and a second tag associated with the second object. For example, the computing device may use one or more machine-learning models to identify objects that are represented in the images. The computing device may then determine, a first depth value associated with the first object and a second depth value associated with the second object. For example, the computing device may use one or more machine-learning models to determine the depth values of various segments of the images that include the first object and/or the second object.

The computing device may then determine, based on the first depth value and the second depth value, a spatial relationship between the first object and the second object. The spatial relationship may include the locations of the first object and the second object in the first image. For example, the computing device may determine that the first object is in the foreground of an image and/or that the second object is larger than the first object. Furthermore, the computing device may generate metadata (e.g., tag data) associated with the first image. The metadata (e.g., tag data) indicate the spatial relationship between objects including the first object and/or the second object. Further, the computing device may embed the metadata (e.g., tag data) into image data associated with any of the images associated with the metadata. As discussed herein, this combination of features may allow for increased effectiveness in generating metadata (e.g., tag data) that leverages the use of depth information to provide spatial relationship information including foreground and background information for objects in an image.

With reference to the figures, example embodiments of the present disclosure will now be discussed in greater detail.

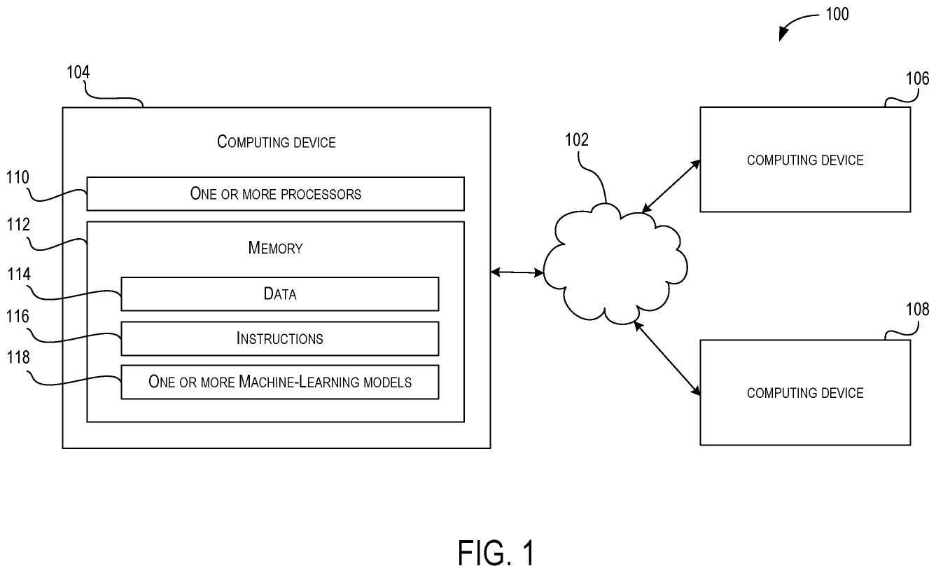

FIG. 1 illustrates an example of a computing system 100 that may be used to implement one or more aspects of the present disclosure discussed herein. In particular, FIG. 1 depicts a diagram of a computing system 100 that is configured to perform operations associated with the generation of metadata (e.g., tag data) for one or more images. As illustrated in FIG. 1, the computing system 100 includes computing device 104, computing device 106, and computing device 108 interconnected via network 102. As shown in FIG. 1, the computing device 104 may comprise one or more processors 110 and memory 112. The memory 112 may store data 114, instructions 116, and/or one or more machine-learning models 118. The computing system 100 may operate in a standalone environment. In some embodiments, the computing system 100 may operate as part of a networked environment. For example, the computing system 100 may operate in conjunction with other computing systems and/or other computing devices not shown in FIG. 1.

The network 102 may include any type of network and may be used to communicate signals, information, and/or data. The network 102 may include any combination of wired and/or wireless networks and may carry any type of signal or communication, including communications and/or signals using one or more communication protocols (e.g., TCP/IP, Ethernet, FTP, HTTP, HTTPS, and the like) and/or one or more wireless communication technologies (e.g., GSM, CDMA, Wi-Fi, LTE, 5G, etc.). The network 102 may, for example, include a local area network (LAN), an intranet, a wide area network (WAN), and/or the Internet. Furthermore, the network 102 may be configured or arranged according to any known topology and/or architecture.

The computing device 104 may, in some embodiments, implement one or more aspects of the present disclosure by accessing and/or executing instructions; and/or performing one or more operations based at least in part on the instructions. In some embodiments, the computing system 100 may be incorporated into and/or include any type of computing device (e.g., a computing device with one or more processors, one or more memory devices, one or more input devices, and/or one or more output devices). By way of example, the computing device 104 may be incorporated into and/or include a desktop computer, a computer server, a computer client, a mobile device (e.g., a laptop computer, a tablet computer, a smart phone, and/or a smart watch), and/or any other type of processing device.

The computing device 104 may include one or more interconnects for communication between different components of the computing device. The computing device 104 may also include a network interface via which the computing device 104 may exchange one or more signals including information and/or data with other computing systems and/or computing devices. For example, the computing device 104 may send information and/or data to the computing device 106 via the network 102. By way of further example, the computing device 104 may receive information and/or data from the computing device 106 via the network 102. Further, the computing device 104 may include one or more input devices (e.g., a keyboard, mouse, touch screen, stylus, and/or microphone) and/or one or more output devices (e.g., a display device and/or audio output devices including loudspeakers).

As seen in FIG. 1, computing device 104 may include one or more processors 110 and a memory 112. The one or more processors 110 may include any combination of processing devices (e.g., one or more computer processing units (CPUs), one or more graphics processing units (GPUs), one or more processor cores, one or more microprocessors, one or more application specific integrated circuits (ASICs), one or more field programmable gate arrays (FPGAs), and/or one or more controllers). Further, the one or more processors 110 may be arranged in different configurations including as a set of serial processors or parallel processors.

The memory 112 may include one or more computer-readable media (e.g., non-transitory computer-readable media) and may be configured to store data and/or instructions including the data 114 and/or the instructions 116. By way of example, the memory 112 may include one or more memory devices including random access memory (RAM), read only memory (ROM), programmable read only memory (PROM), erasable programmable read only memory (EPROM), electrically erasable programmable read only memory (EEPROM), solid state drives (SSDs), hard disk drives (HDDs), and/or hybrid memory devices that use a combination of different memory technologies. Further, the memory 112 may store one or more machine-learning models including the one or more machine-learning models 118.

The one or more machine-learning models 118 may be configured and/or trained to analyze one or more images, detect one or more objects contained in the images, and/or generate one or more depth values for the one or more objects. Furthermore, the one or more machine-learning models 118 may utilize any combination of algorithms and/or techniques. The one or more machine-learning models 118 may include one or more convolutional neural networks (CNNs), one or more recurrent neural networks (RNNs), a recursive neural network, a long short-term memory (LSTM), a gated recurrent unit (GRU), an unsupervised pre-trained network, a space invariant artificial neural network, one or more generative adversarial networks (GANs), one or more consistent adversarial networks (CANs), and/or one or more support vector machines (SVMs). Further, the one or more machine-learning models 118 may be trained to analyze one or more images, detect one or more objects contained in the images, and/or generate one or more depth values for the one or more objects. The one or more machine-learning models 118 may be trained using supervised learning, unsupervised learning, back propagation, transfer learning, stochastic gradient descent, learning rate decay, dropout, max pooling, batch normalization, long short-term memory, skip-gram, or any equivalent deep learning technique. Once the one or more machine-learning models 118 are trained, the one or more machine-learning models 118 may be exported and/or deployed, for example, in one or more databases or applications. Once deployed, the one or more machine-learning models 118 may use one or more techniques and/or algorithms including random forest, boosted gradients, one or more decision trees, k-means clustering, k-nearest neighbors (k-NN), regression, Bayesian networks, and/or one or more relevance vector machines to analyze one or more images, identify one or more objects contained in the images, generating depth values associated with each of the one or more objects, and generate metadata (e.g., tag data) based on the identification of the one or more objects and the depth values associated with each of the one or more objects. Further, the computing device 104 may use other statistical analysis methods including multivariate or univariate statistical analysis.

The computing device 106 and/or the computing device 108 may include any of the attributes, features, and/or capabilities of the computing device 104. For example, the computing device 106 and/or the computing device 108 may include one or more processors, a memory, one or more input devices, and/or one or more output devices

Further, the computing device 106 and/or the computing device 108 may have different or similar configurations and/or architectures to that of the computing device 104. Furthermore, any combination of the computing device 104, the computing device 106, and/or the computing device 108 may operate separately and/or together. For example, performance of operations may be distributed among the computing device 104 and the computing device 106.

One or more aspects discussed herein may be embodied in computer-usable, computer-readable data, and/or computer-executable instructions, which may be stored as data and/or instructions in one or more memory devices and/or executed by one or more computing devices or other devices as described herein. Generally, the data and/or instructions may include software applications, routines, computing programs, functions, objects, components, data structures, and the like that may perform particular tasks or implement particular abstract data types when executed by one or more processors in a computing device or other device. The data and/or instructions be written in a source code programming language that is subsequently compiled for execution, or may be written in a scripting language including (but not limited to) HTML or XML. The computer executable instructions may be stored on a computer readable medium (e.g., a non-transitory computer-readable medium) such as a hard disk, solid state drive, optical disk, removable storage media, solid state memory, RAM, etc. As will be appreciated by a person having skill in the art, the functionality of the computing applications described herein may be combined or distributed in various embodiments. Further, the functionality may be embodied partly or wholly in firmware or hardware equivalents including integrated circuits, field programmable gate arrays (FPGA), and the like. Particular data structures may be used to more effectively implement one or more aspects discussed herein, and such data structures are contemplated within the scope of computer executable instructions and computer-usable data described herein.

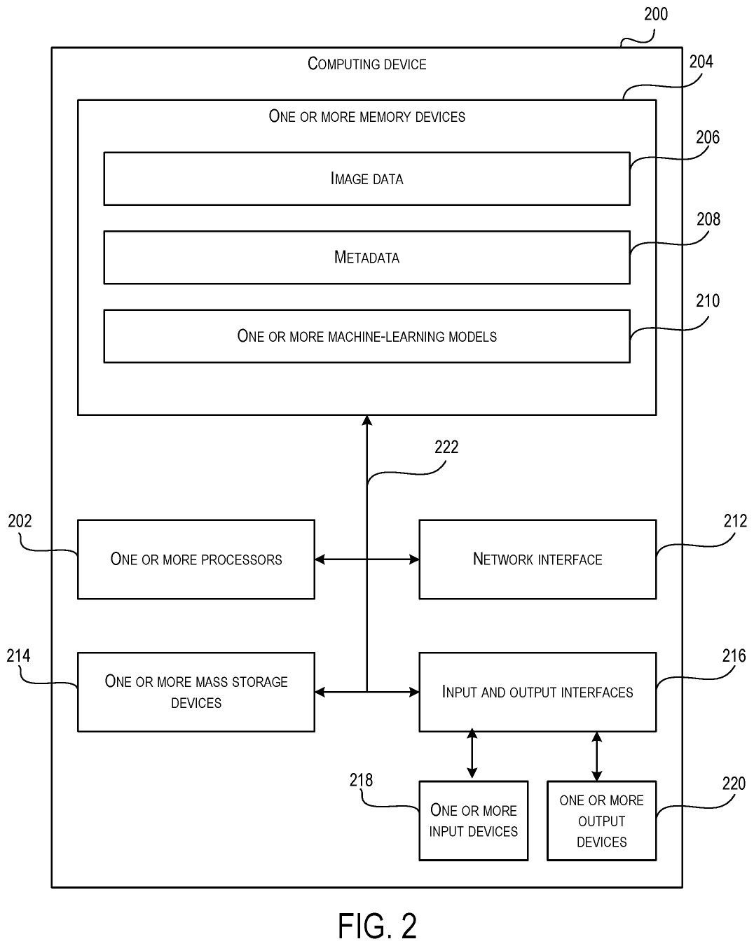

Any of the devices and systems described herein may be implemented, in whole or in part, using one or more computing devices described with respect to FIG. 2. FIG. 2 illustrates one example of a computing device 200 that may be used to implement one or more illustrative aspects discussed herein. For example, the computing device 200 may, in some embodiments, implement one or more aspects of the present disclosure. Further, the computing device 200 may include any of the features and/or capabilities of the computing system 101 that is illustrated in FIG. 1.

The computing device 200 may include one or more processors 202, one or more memory devices 204, a network interface 212, one or more mass storage devices 214, input and output interfaces 216, one or more input devices 218, one or more output devices 220, and/or one or more interconnects 222. The one or more memory devices 204 may store image data 204, metadata 208, and/or one or more machine-learning models 210. The computing device 200 is not limited to the configuration depicted in FIG. 2 and may include any number of processors, memory devices, mass storage devices, input and output interfaces, interconnects, and/or network interfaces. Further, any of the processors, memory devices, mass storage devices, input and output interfaces, interconnects, and/or network interfaces may be provided as any combination of separate components and/or as parts of the same component.

The one or more processors 202 may include one or more computer processors that are configured to execute one or more instructions stored in the one or more memory devices 204. The one or more processors 202 may include one or more central processing units, one or more application specific integrated circuits (ASICs), one or more graphics processing units (GPUs), and/or one or more field programmable arrays (FPGAs). Additionally or alternatively, the one or more processors 202 may include single core devices and/or multiple core devices that may include one or more microprocessors, one or more microcontrollers, one or more integrated circuits, and/or one or more logic devices. Furthermore, the one or more processors 202 may perform one or more operations comprising one or more operations to process the image data 206 and/or the metadata 208. For example, the one or more processors 202 may perform one or more operations comprising accessing the image data 206. The one or more processors 202 may use the one or more machine-learning models 210 to analyze the image data 206, detect objects in the image data 206, determine spatial relations of the detected objects, and/or generate the metadata 208 for each of the objects in the image data 206. The metadata 208 may comprise a label (e.g., title) associated with the object contained in the image data 206. Additionally or alternatively, the metadata 208 may include information associated with the location (e.g., spatial relationship) for each of the objects in the image data 206.

The one or more memory devices 204 may store information and/or data (e.g., the image data 206 and/or the metadata 208). Further, the one or more memory devices 204 may include one or more non-transitory computer readable storage media, including RAM, ROM, EEPROM, flash memory devices, magnetic disks, and/or any of the memory devices described herein (e.g., the memory 112 illustrated in FIG. 1). The information and/or data stored by the one or more memory devices 204 may include instructions to perform one or more operations. Further, the instructions stored by the one or more memory devices 204 may be executed by the one or more processors 202. Execution of the instructions may cause the computing device 200 to perform one or more operations including the one or more operations described herein.

The one or more memory devices 204 and/or the one or more mass storage devices 214 are depicted as separate entities in FIG. 2. However, the one or more memory devices 204 and/or the one or more mass storage devices 214 may occupy different portions of the same memory device. The one or more memory devices 204 and/or the one or more mass storage devices 214 may include one or more computer-readable media that may include but is not limited to non-transitory computer-readable media described above.

The one or more memory devices 204 may store instructions for one or more applications. The one or more applications may include an operating system that may be associated with various software applications and/or data. In some embodiments, the one or more memory devices 204 may store an operating system that executes on the computing device 200. Further, the one or more memory devices 204 may store instructions that allow software applications to access data, including the image data 206 and/or the metadata 208.

The software applications that may be executed by the computing device 200 may include applications associated with the computing system 100 that is depicted in FIG. 1. Further, the software applications operated by the computing device 200 may include applications that operate locally and/or applications that are executed remotely (e.g., web applications that are executed on a server computing device with inputs received by the computing device 200 which may operate as a client device).

The image data 206 may include one or more portions of data (e.g., the data 114) and/or instructions (e.g., the instructions 116) that are stored in the memory 112. Furthermore, the image data 206 may include information associated with a plurality of images which may include representations of one or more objects. The information may comprise a plurality of points in each image. Each point, of the plurality of points, may be associated with a corresponding position value, color value, and/or brightness value. Additionally the image data 206 may include location information (e.g., latitude and longitude, etc.).

The metadata 208 may include information associated with one or more tags (e.g., one or more semantic tags). In some embodiments, one or more portions of the metadata 208 may be stored as part of the image data 206. The metadata 208 may include information associated with the image data 206. The information may include one or more tags associated with the size of an image represented in the image data 206, depth values associated with one or more objects represented in the image data 206, classes of objects represented in images represented in the image data 206, and/or information indicating one or more foreground and/or background segments of images represented in the image data 206. Additionally or alternatively, the information contained in the metadata 208 may include labels associated with each of the objects contained in the image data 206, and the like.

The one or more machine-learning models 210 may include any features and/or capabilities of the machine-learning models described above (e.g., the one or more machine-learning models 118 that are illustrated in FIG. 1). For example, the one or more machine-learning models 210 may include a convolutional neural network that is configured and/or trained to analyze one or more images to detect one or more objects in the one or more images and/or to estimate the depth of objects in one or more images. The one or more machine-learning models 210 may be configured and/or trained using training data and/or a loss function. For example, the one or more machine-learning models 210 may be configured to receive training data as an input to configure and/or configure the machine-learning models 210. The training data may include a plurality of training images that may include one or more labels to identify the content represented by the corresponding image. The one or more machine-learning models 210 may then perform one or more operations associated with extracting one or more features of images included in the training data. For example, the one or more machine-learning models 210 may include one or more layers (e.g., convolutional layers, pooling layers, rectified linear unit (ReLU) correction layers, and/or fully connected layers) that are used to extract features of the one or more images included in the training data.

The one or more machine-learning models 210 may then generate an output that may include detection of one or more objects, labels applied to each of the one or more objects, classification of one or more segments of the input image into foreground and/or background layers, and/or estimation of depth values associated with one or more objects in the input image. A loss corresponding to the output may be determined by using a loss function with one or more aspects of the output being used as an input to the loss function. The loss function may be associated with an accuracy of detecting one or more objects represented in an image and/or an accuracy of estimating the depth of one or more objects represented in an image. The one or more machine-learning models 210 may then adjust the weighting of one or more parameters of the one or more machine-learning models 210 based at least in part on the loss that was determined. For example, the one or more parameters that are determined to make less of a contribution to minimizing the loss may be weighted more heavily and the one or more parameters that make less contribution to minimizing the loss may be weighted less heavily. Over a plurality of training iterations, the one or more parameters associated with the one or more machine-learning models 210 may be adjusted based at least in part on the respective contributions of the one or more parameters.

The one or more interconnects 222 may include one or more interconnects or buses that may be used to send and/or receive one or more signals (e.g., electronic signals) and/or data (e.g., the image data 206 and/or the metadata 208) to and/or from one or more components of the computing device 200 (e.g., the one or more memory devices 204, the one or more processors 202, the network interface 212, the one or more mass storage devices 214, and/or the input and output interfaces 216). The one or more interconnects 222 may be configured and/or arranged in various ways including as parallel or serial connections. Further, the one or more interconnects 222 may include one or more internal buses to connect the internal components of the computing device 200; and/or one or more external buses to connect the internal components of the computing device 200 to one or more external devices. For example, the one or more interconnects 222 may include different interfaces including ISA, EISA, PCI, PCI Express, Serial ATA, Hyper Transport, and/or other interfaces that may be used to connect components of the computing device 200.

The network interface 212 may support network connections including connections to communicate via one or more networks. The one or more networks to which the computing device 200 is connected via the network interface 212 may include a local area network, a wide area network, and/or the Internet.

The one or more mass storage devices 214 may be used to store data including the image data 206 and/or the metadata 208. The one or more mass storage devices 214 may include one or more solid state drives (SSDs) and/or one or more hard disk drives (HDDs).

The input and output interfaces 216 may include one or more input interfaces to receive input from the one or more input devices 218 and/or the one or more output devices 220. The one or more input device 218 may be used to provide one or more inputs to the computing device 200. The one or more input devices 218 may include one or more keyboards, one or more mouse devices, one or more touch input devices (e.g., a capacitive touch screen and/or a resistive touch screen), one or more microphones, and/or one or more cameras. The one or more output devices 220 may include one or more visual output devices (e.g., display devices including LCD displays and/or OLED displays) and/or one or more audio output devices (e.g., one or more loudspeakers).

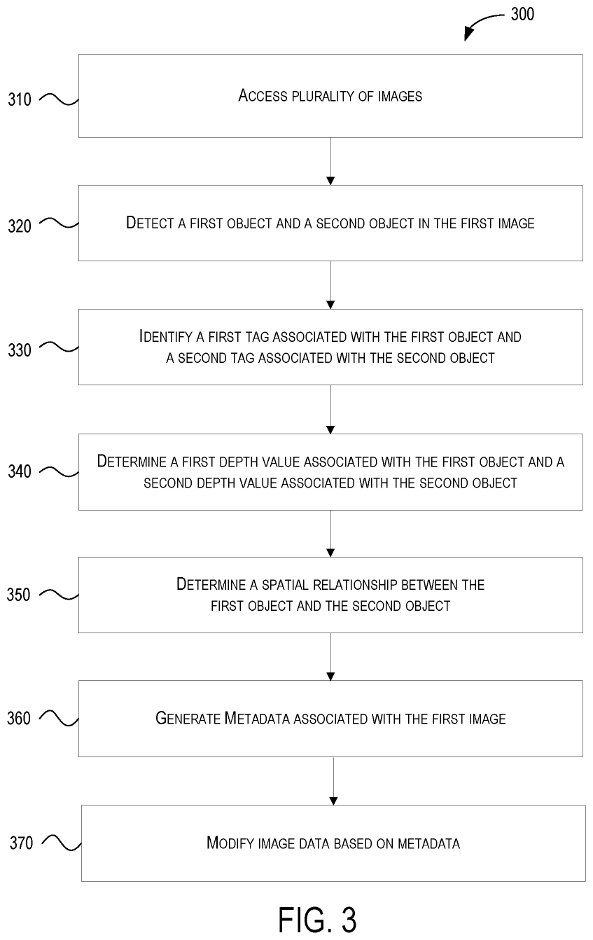

In order to help search and/or find images, images may be tagged with metadata identifying one or more objects in an image. The metadata may then be searched using keywords and/or phrases to locate relevant images. FIG. 3 illustrates an example of a method for generating metadata for images according to one or more aspects of the disclosure. The method 300 may be implemented by a computing system and/or computing device including any of the computing systems and/or computing devices described herein. For example, one or more steps and/or one or more portions of the method 300 may be implemented by the computing device 104 that is illustrated in FIG. 1 and/or the computing device 200 that is illustrated in FIG. 2. Further, the method 300 may be a computer-implemented method that is implemented in the form of instructions that are executed by a computing system and/or computing device.

At step 310, a computing device may access, receive, obtain, and/or retrieve a plurality of images. The plurality of images may be stored in an image repository. Further, the plurality of image may comprise a first image. For example, the computing device may access images from a remote computing system that provides a plurality of images and/or information associated therewith that is stored in an image database and/or an image repository. Alternatively, the computing device may access the images from a local repository, such as a photo album located on the computing device.

Any of the plurality of images may be associated with image data. The image data may comprise information associated with the first image. Additionally or alternatively, the image data may include and/or be associated with one or more features and/or one or more aspects of the image. The image data may include information associated with a data format of the image data (e.g., whether the image data is encoded in PNG, BMP, or JPEG format), a file size of the image data (e.g., a size in kilobytes), a resolution of an image associated with the image data (e.g., the number of points (e.g., pixels) in the image and/or the number of points in each axis of the image (e.g., the number of points in the x and y axis for a two-dimensional image and the number of points in the x, y, and z axes for a three-dimensional image), an image type (e.g., whether the image data is associated with a still image or a video), and/or geolocation information (e.g., the location at which an image was captured). In some embodiments, the plurality of images may comprise and/or be associated with one or more videos (e.g., video which may be encoded in a format such as H.264 (MPEG-4 Part 10), H.265 (high efficiency video codec), or AV1). For example, the image data may comprise video that includes a plurality of images.

Any of the plurality of images including the first image may include a plurality of points (e.g., a plurality of pixels). For example, the first image may include information associated with a position, color, and/or brightness of each of the plurality of points of the first image. For example, each of the plurality of points may be encoded according to a color space (e.g., YUV, RGB, CMYK, etc.).

At step 320, the computing device may detect one or more objects in any of the plurality of images. In particular, the computing device may detect a first object in the first image and/or a second object in the first image. The computing device may use one or more image processing techniques to detect objects including the first objects and/or the second object. For example, the computing device 104 may perform one or more image detection operations on the first image. The one or more image processing techniques may include one or more facial recognition techniques, one or more object recognition techniques, and/or any suitable algorithms to detect one or more objects in an image. The one or more image processing techniques referred to above may include one or more scale invariant feature transform (SIFT) techniques and/or one or more histogram of oriented gradients (HOG) techniques. Further, one or more portions of the image data and/or the first image may be provided as an input that is processed by one or more image processing techniques that provide output including an indication of whether one or more objects have been detected in an image and/or one or more classes of one or more objects that are represented in an image. For example, the computing device may be configured to execute a SIFT technique on the first image and detect one or more objects including individuals and buildings that are represented in the first image. Further, detecting the one or more objects may include accessing the metadata associated with the first image and determining whether the metadata includes an indication of one or more depth values in the first image and/or one or more objects in the first image.

In some embodiments, one or more machine-learning models may be configured and/or trained to detect objects including the first object and/or the second objects. The one or more machine-learning models may analyze one or more images to detect and/or recognize one or more objects in the one or more images. The one or more machine-learning models may include one or more convolutional neural networks or any suitable machine-learning model. For example, a portion of the first image may be inputted into one or more machine-learning models to detect one or more objects (e.g., the first object and/or the second object) contained the first image. The one or more machine-learning models may then generate an output that includes one or more indications of the one or more objects that were detected in the first image. For example, the computing device (e.g., computing device 104) may use one or more machine-learning models to detect objects, faces, landmarks, etc. in images.

In some embodiments, the one or more image processing techniques may include the determination of one or more segments in an image (e.g., the first image and/or the second image). To determine the one or more segments, a computing device may determine a plurality of points (e.g., a plurality of pixels) in which each of the plurality of points are associated with a color value. Points that have the same, or similar, color values and/or color intensities may be grouped together. Points that have the same, or similar, color values and/or color intensities and that are proximately located may be grouped to form a boundary. The computing device may then generate the plurality of segments based on boundaries between different portions of the image. The boundaries may indicate the presence of one or more objects.

At step 330, the computing device may identify, using one or more machine-learning models, a first tag associated with the first object and a second tag associated with the second object. The computing device may determine a class and/or identify of the first object and/or the second object. For example, the computing device may use one or more machine-learning models to recognize and/or identify the first object is a person and the second object is a motor vehicle. Identifying the first tag associated with the first object and the second tag associated with the second object may further comprise applying a first label to the first object and a second label to the second object. For example, the computing device may label the first object as a person and the second object as a motor vehicle. Further, the first label and/or the second label may be based on one or more classifications. Further, the first label and/or the second label may be written to the metadata along with the spatial relationship. The one or more classifications may comprise at least one of: a person, an animal, a vehicle, a landmark, a foreground, and/or a background.

The computing device may use the image as an input to the one or more machine-learning models. The one or more machine-learning models may be used to detect foreground and background objects of an image. Further, the one or more machine-learning models may be configured and/or trained to detect and/or recognize (e.g., generate a classification for an object) one or more objects (e.g., the first objects and/or the second object) that are visible within an image. For example, the one or more machine-learning models may use input comprising the first image and/or the second image to generate a first tag for the first image and a second tag for the second image.

The computing device may determine one or more classes associated with the objects (e.g., the first object and/or the second object). The one or more classes may be determined, for example, based on use of the one or more machine-learning models. For example, the one or more machine-learning models may be configured to output one or more classifications of associated with each of the one or more objects (e.g., the first object and/or the second object). The one or more classifications may include one or more people (e.g., full or partial bodies or faces of one or more people), one or more animals (e.g., dogs, cats, or birds), vehicles (e.g., automobiles, airplanes, and/or boats), landmarks (e.g., famous buildings or monuments), foreground, background, and the like. For example, the computing device (e.g., computing device 104) may use one or more machine-learning models to determine one or more classes/classifications associated with an image of a landmark (e.g., the Bronze Horseman statue in Saint Petersburg). The computing device (e.g., computing device 104) may then generate output classifying the object as a statue, a landmark, and in the foreground.

At step 340, the computing device may determine one or more depth values. For example, the computing device may detect a first depth value associated with the first object and/or a second depth value associated with the second object. The one or more depth values may be associated with the one or more objects represented in the first image. The one or more depth values (e.g., the first depth value and/or the second depth value) may be associated with one or more segments of the image. The one or more segments may range in size from a single point, of the plurality of points of the first image, to every one of the points of the plurality of points of the first image. In some embodiments, the one or more segments may comprise a contiguous portion of the first image. For example, an image including a representation of a vehicle that is bisected by a lamp post may be determined to include three segments comprising a first segment associated with the lamp post, as second segment associated with the portion of the vehicle on one side of the lamp post, and a third segment associated with the portion of the vehicle on the other side of the lamp post.

In some embodiments, determination of the one or more depth values may be based at least in part on use of one or more machine-learning models configured and/or trained to receive an input (e.g., an input comprising the image data and/or the first image) and based on the input generate an output including the one or more depth values (e.g., a first depth value associated with the first object and a second depth value associated with the second object).

The computing device may use the portion of the image as an input to one or more machine-learning models that are configured and/or trained to determine the one or more depth values (e.g., the first depth value and/or the second depth value) associated with the portion of the image. The output (e.g., one or more depth values) of the one or more machine-learning models may be based on the inputted portion of the image. Further, the one or more machine-learning models may perform one or more operations that generate a depth map for the first image. The depth map may include a representation of the first image in which each of a plurality of portions (e.g., a plurality of points or pixels) of the image is assigned a depth value that is associated with the depth of the respective point. The one or more depth values corresponding to the one or more objects detected in the first image may be used to determine one or more depth values for the one or more objects. For example, the computing device 104 may use one or more machine-learning models to generate a first depth value corresponding to the first object and a second depth value corresponding to the second object.

At step 350, the computing device may determine a spatial relationship between the first object and the second object. The spatial relationship may comprise the locations of the first object and the second object. Determination of the spatial relationship may be based on depth values comprising the first depth value and/or the second depth value. For example, the computing device (e.g., computing device 104) may determine the spatial relationship by determining the location and/or size of each of the one or more objects relative to the location and/or size of the other objects.

In some embodiments, the spatial relationship may be associated with and/or indicate: the one or more objects that are in the foreground or the background relative to any other of the one or more objects in the first image; one or more proportions of the first image that are occupied by any of the one or more objects; one or more portions of the one or more objects that are obstructed by any other object of the one or more objects; and/or one or more sizes of the one or more objects relative to at least one other object of the one or more objects. For example, the computing device (e.g., computing device 104) may determine whether any of the one or more objects overlap and/or are overlapped by one or more other objects. The one or more objects that overlap another object may be determined to be in the foreground relative to that object. The one or more objects that are overlapped by another object may be determined to be in the background relative to that object. With respect to determining the one or more proportions, the computing device (e.g., computing device 104) may determine the largest of the one or more objects in the first image based on spatial relations relating to the size of the object relative to the size of the first image. For determining whether a first objects is obstructed by a second object, the computing device may determine the amount of each of the one or more objects that is obstructed by any other object of the one or more objects and thereby determine the object that is the most obstructed and the object that is the least obstructed. Finally, in order to determine the size of the objects, the computing device may determine a relative size of each of the one or more objects relative to every other object of the one or more objects.

The determination of the spatial relationship may be based on analysis and operations performed by the one or more machine-learning models described herein. The one or more machine-learning models may be configured and/or trained to receive an input (e.g., the first image) and, based on the input, generate an output that identifies (e.g., labels) one or more objects and includes the spatial relationship between the objects (e.g., the first object and the second object).

At step 360, the computing device may generate metadata. The metadata may include an indication of the spatial relationship between the first object and the second object. For example, the computing device may generate metadata indicating that the first object is in the foreground relative to the background, that the first object is larger than the second object, and/or that the first object is above the second object. Further, the metadata that is generated may include one or more indications of one or more classifications associated with the first object and/or the second object.

The metadata may be associated with the first image and/or one or more objects in the image (e.g., the first object and/or the second object). In some instances, the metadata may be associated with a portion of the one or more objects. For example, the metadata may be associated with an object that a person is holding. In some instances, the metadata may include information associated with the spatial relationship between two or more objects in the first image. For example, the computing device (e.g., computing device 104) may generate metadata that includes an identifier (e.g., file name) associated with the name or location of the corresponding image. Further, the metadata may include one or more depth values (e.g., the first depth value and/or the second depth value) corresponding to each of the one or more objects represented in the corresponding image associated with the image. The spatial relationship information may include the sizes of the one or more objects, an indication of the largest object in an image, an indication of the smallest object in a scene, indications of the one or more locations of one or segments of the image and corresponding information regarding whether the one or more segments are background or foreground relative to at least one other segment, and/or one or more classes of the one or more objects.

The computing device may add information and/or data associated with the one or more classes (classifications) of the one or more objects to the metadata. For example, the information associated with the Bronze Horseman statue classified in step 330 may be added to the metadata. When the images are subsequently searched for the “Bronze Horseman,” the image of the Bronze Horseman in the foreground of the image may be returned as a search result. For example, the computing device (e.g., computing device 104) may access the metadata when performing a search and discover the image tagged as the Bronze Horseman and add metadata indicating that the particular image of the Bronze Horseman is a statue, a landmark, and in the foreground.

At step 370, the computing device may modify image data (e.g., the image data described at step 310) that is associated with any of the plurality of images (e.g., the first image). The image data may be modified based at least in part on the metadata. Modifying the image data may include adding one or more portions of the metadata to the image data, deleting one or more portions of the metadata associated with the image data, and/or adjusting one or more portions of the metadata associated with the image data. For example, the computing device (e.g., computing device 104) may access image data and add metadata (e.g., metadata that includes depth values of one or more objects represented in the image date) to image data that does not include information associated with the depth of objects represented in corresponding images.

The method 300 improves the speed and accuracy with which computing devices perform image analysis to identify objects in an image. The combination of the image processing techniques and machine-learning models ensure that the computing device accurately tags and/or labels people and/or objects in an image. By adding the tags and/or labels to the corresponding images, subsequent searches are able to be performed using fewer processing resources (e.g., less processor cycles and less memory consumed).

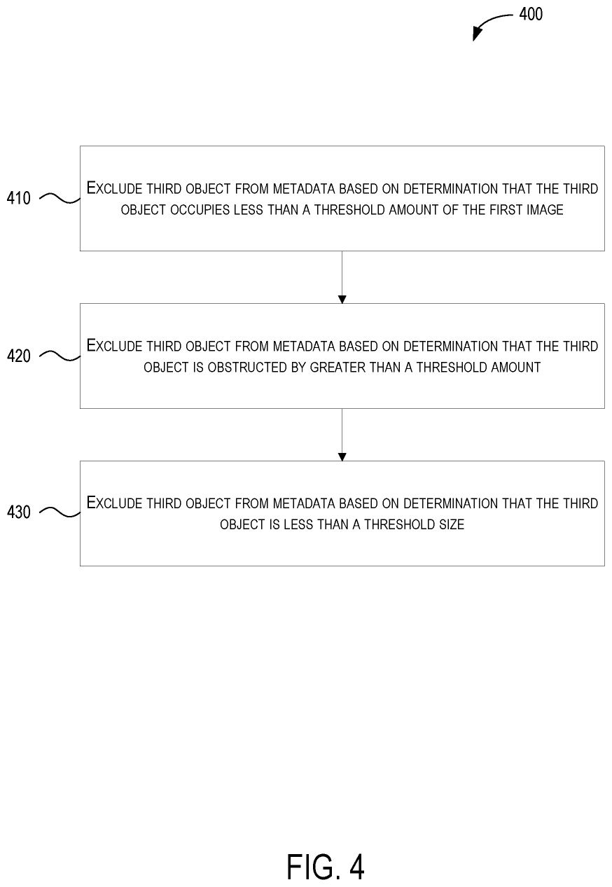

When detecting the one or more objects in an image, objects may not be tagged for a variety of reasons. For example, if an object is too small or is obscured by another object, there may not be a point to tagging the object. FIG. 4 illustrates an example flow chart for a method of detecting objects in an image according to one or more aspects of the disclosure. The method 400 may be implemented by a computing system and/or computing device including any of the computing systems and/or computing devices that are described herein. For example, one or more steps and/or one or more portions of the method 400 may be implemented by the computing device 104 that is illustrated in FIG. 1 and/or the computing device 200 that is illustrated in FIG. 2. Further, the method 400 may be a computer-implemented method that is implemented in the form of instructions that are executed by a computing system and/or computing device. In some embodiments, one or more steps and/or one or more portions of the method 400 may be performed as part of the method 300 that is depicted in FIG. 3.

At step 410, a computing device (e.g., computing device 104) may exclude a third object from the metadata based on a determination that the third object occupies less than a threshold amount of the first image. For example, the computing device (e.g., computing device 104) may determine a total size of an image based on image data that indicates the resolution of the image. The computing device (e.g., computing device 104) may then determine the proportion of the total size of the image that is occupied by each of the one or more objects, for example, as part of step 320 in FIG. 3. The computing device (e.g., computing device 104) may then determine that a third object, of the one or more objects, occupies less than a threshold amount of the total size of the image. Based on a determination that the third object occupies less than the threshold amount of the first image, the third object may be excluded from the metadata. That is, the third object may not be tagged (e.g., labelled).

At step 420, the computing device may exclude a third object from the metadata based on a determination that the third object is obstructed by greater than a threshold amount. For example, the computing device (e.g., computing device 104) may determine a size of each of the one or more objects in an image based on image data that indicates the resolution of the image, for example, during step 320 in FIG. 3. The computing device (e.g., computing device 104) may then determine the proportion of each of the one or more objects that is obstructed by another object of the one or more objects. The computing device (e.g., computing device 104) may then determine that a third object that is obstructed by greater than a threshold amount be excluded from the metadata.

At step 430, the computing device may exclude excluding a third object from the metadata based on a determination that the third object is less than a threshold size. For example, the computing device (e.g., computing device 104) may determine a size of a third object represented in an image. The computing device (e.g., computing device 104) may then compare the third object to a threshold size. The threshold size may be a threshold number of pixels of the image, and/or a threshold size relative to another object in the image (e.g., the threshold size may be based on the size of the first object and/or the second object). The computing device (e.g., computing device 104) may then determine that if the third object occupies less than a threshold size that the third object may be excluded from the metadata.

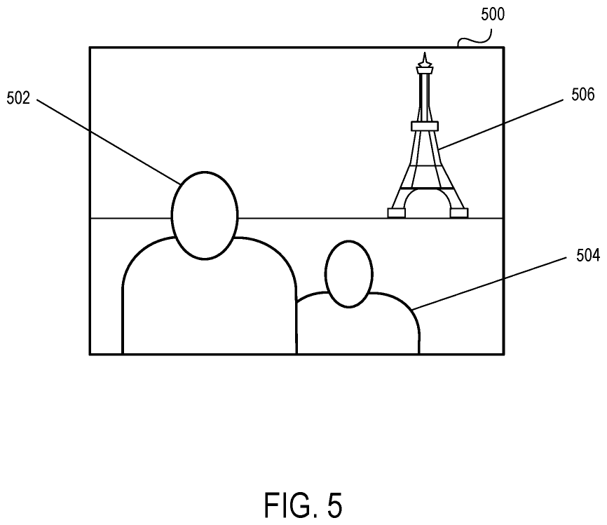

Using the techniques described herein, users may perform an image query that contains search terms and retrieve one or more images contain metadata (e.g., tag data) that are associated with the user's search terms. FIG. 5 illustrates an example of an image 500 retrieved based on metadata according to one or more aspects of the disclosure. Any of the operations described as part of generating metadata for the image 500 may be performed by any of the computing systems and/or computing devices that are described herein. Further, any of the operations described as part of generating metadata for the image 500 may be performed by a computing system and/or computing device that includes one or more features and/or capabilities of the computing systems and/or computing devices that are described herein.

The image 500 may have been returned as the result of an image search that accessed, received, obtained, and/or retrieved tagged image data that was generated based at least in part on any of the techniques described herein. In some embodiments, the search result may be based at least in part on a search that includes one or more references (e.g., one or more search terms) associated with one or more objects. For example, a user may enter the search term “PEOPLE STANDING IN FRONT OF THE EIFFEL TOWER” into a search engine. The search engine may then access a dataset that includes metadata. As noted above, the metadata may include one or more tags that describe various features of one or more images. Further, the metadata may indicate one or more objects and one or more corresponding classes of one or more objects that are represented in the images contained in the dataset. For example, the metadata may indicate that an image includes a representation of one or more people, one or more places, and/or one or more things (e.g., geographic landmarks). Returning to the example above, image 500 may comprise one or more tags that indicate: first person 502, second person 504, and/or building object 506. As shown in FIG. 5, building object 506 may be the Eiffel Tower and be tagged accordingly. Thus, the search engine may return the image 500 to the user in response to receiving the search query: “PEOPLE STANDING IN FRONT OF THE EIFFEL TOWER.”

Further, the tagged data and/or tagged image data may indicate one or more spatial relationships including whether any of the one or more objects represented in the image 500 are in the foreground and/or background relative to any of the other objects represented in the image 500. For example, the metadata may indicate that the second person 504 depicted in the image 500 is in the foreground of the image relative to the building object 506 and (slightly) in the background relative to the first person 502.

Further, the metadata may include one or more depth values associated with a distance from an image capture device (e.g., a camera) to any of the one or more objects that are represented in the image. For example, the metadata may indicate that the first person 502 is three (3) meters from the image capture device and that the building object 506 (i.e., Eiffel Tower) is more than one-hundred (100) meters from the image capture device. The one or more depth values can, for example, be based, at least in part, on LiDAR returns that were collected at the time the image 500 was captured. Additionally or alternatively, the one or more depth values may be based on one or more of the following: one or more color values, one or more color intensities, one or more pixel values, etc.

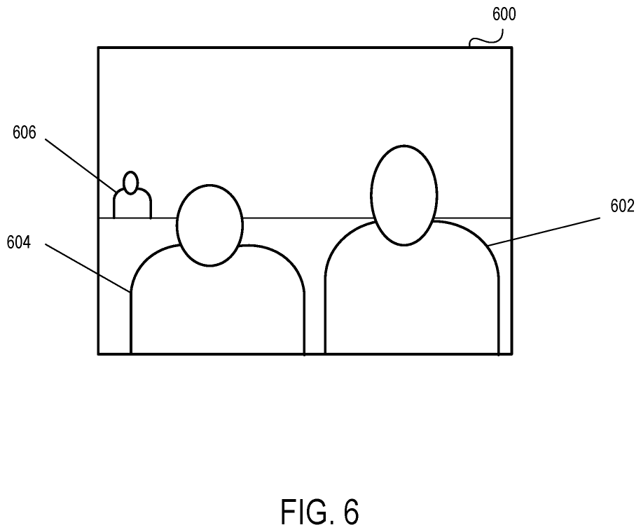

FIG. 6 illustrates another example of an image 600 retrieved based on metadata according to one or more aspects of the disclosure. Any of the operations described as part of generating metadata for the image 600 may be performed by any of the computing systems and/or computing devices that are described herein. Further, any of the operations described as part of generating metadata for the image 600 may be performed by a computing system and/or computing device that includes one or more features and/or capabilities of the computing systems and/or computing devices that are described herein.

The image 600 may have been returned as the result of an image search that accessed, received, obtained, and/or retrieved tagged image data that was generated based at least in part on any of the techniques described herein. In some embodiments, the search result may be based at least in part on a search that includes one or more references (e.g., one or more search terms) associated with one or more objects. For example, a user may enter the search term “MILA WITH VLADIMIR” into a search engine. The search engine may then access a dataset that includes metadata. In this example, the computing device (e.g., the computing device 104) may perform a search of a dataset that includes personal photographs captured by a user (e.g., the user that created the search). Using the techniques described herein, the computing device may have generated metadata that includes name tags (e.g., metadata with the names “MILA” and “VLADIMIR”) associated with the same image. Additionally or alternatively, the computing device may have generated metadata that includes the name tags using facial recognition techniques. Further, the metadata may include depth information including one or more depth values associated the objects represented in the images. The search term “WITH” may be used to search for images in which the searched for objects of “VLADIMIR” and “MILA” are both in the same image and may be in close proximity (e.g., within some predetermined distance of one another) relative to one another. For example, the image 600 may be associated with metadata that includes depth values indicating that the name tags are associated with depth values that are approximately (e.g., within a predetermined distance threshold) the same. Other search terms may be used in place of “WITH,” including, for example “AND.”

Returning to the example shown in FIG. 6, the image 600 may include metadata that indicates that the objects (e.g., Mila and Vladimir) are within approximately the same depth plane. Further, the tagged data and/or tagged image data may indicate whether the Vladimir object 602 or the Mila object 604 are in the foreground and/or background relative to any of the other objects represented in the image 600. For example, the metadata may indicate that the person object 606 depicted in the image 600 is in the background of the image 600 relative to the Vladimir object 602 and the Mila object 604.

In yet a further example, and as noted above, the metadata may include one or more depth values associated with a distance an object is from an image capture device (e.g., a camera). For example, the metadata may indicate that the person object 606 is fifty (50) meters from the image capture device, while the Vladimir object 602 and the Mila object 604 are two (2) meters from the image capture device. Because of how far the person object 606 is from the camera, the person object 606 may be not be tagged. Alternatively, the person object 606's distance from the camera may cause the tag to be weighted less when the tag is used as a search term.

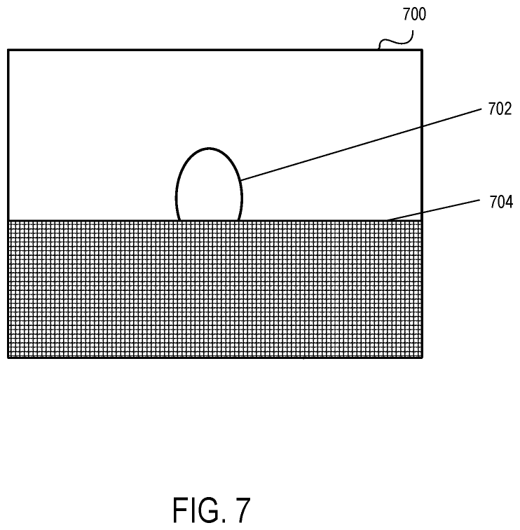

FIG. 7 illustrates yet another example of an image retrieved based on metadata according to one or more aspects of the disclosure. Any of the operations described as part of generating metadata for the image 700 may be performed by any of the computing systems and/or computing devices that are described herein. Further, any of the operations described as part of generating metadata for the image 700 may be performed by a computing system and/or computing device that includes one or more features and/or capabilities of the computing systems and/or computing devices that are described herein.

The image 700 may comprise a first person 702 and an object 704. The first person 702 may be tagged with a name using the machine-learning techniques described herein and/or facial recognition techniques. For the purposes of image 700, the name associated with the first person 702 is “Sam.” The object 704 may be identified as a wall by one or more computing devices. The first person 702 and the object 704 may be tagged using an image segmentation technique. The image segmentation techniques may begin with identifying a plurality of points (e.g., a plurality of pixels) that are associated with respective color values. Points that have the same, or similar, color values and/or color intensities may be grouped together. Points that have the same, or similar, color values and/or color intensities and that are proximately located may be grouped to form a boundary. The computing device may generate the plurality of segments based on boundaries between different portions of the image 700. Returning to the example shown in FIG. 7, a plurality of segments may be generated based on boundaries between different portions of the image 700. For example, a first segment may be based on the boundaries between the outline of the first person 702 (“SAM”) and objects that may intersect the outline of the Sam object. The first segment may be tagged as a first person 702. Similarly, the machine learning techniques and/or facial recognition techniques may be used to apply a label to the first person 702. As noted above, the machine learning techniques and/or facial recognition techniques may tag the first person 702 as “Sam.” A second segment may be generated based on the boundaries of a wall in front of the first person 702. Like the first segment, the second segment may be based on the boundaries of the object 704 with its surroundings. The machine learning techniques and/or image analysis techniques may tag the object 704 as a “wall.”

Image 700 may be returned as a result of a search that includes one or more references (e.g., one or more search terms) associated with one or more objects. For example, a user searching for images of their friend “Sam” may enter the search term “SAM ON THE FRONT PORCH” into a search engine that searches for content stored on the user's computing device (e.g., the user's mobile device). The search engine may then access a dataset (e.g., a photo library on the user's mobile device) that includes metadata. As noted above, the metadata may include one or more tags that describe various features of the one or more images stored on the user's computing device, including one or more objects, one or more corresponding classes of one or more objects, one or more people, one or more locations, and/or one or more things (e.g., geographic landmarks). As noted above, the metadata may indicate and/or describe a spatial relationship between two or more objects, including whether an object is in the foreground and/or background and/or the location of an object relative to other objects. As shown in FIG. 7, the metadata may indicate that the first person 702 is in the background of the image 700 relative to the object 704. Additionally or alternatively, the metadata may indicate that the object 704 is in front of (and partially obstructs) the first person 702. The metadata may also include one or more depth values associated with an object. As discussed above, the one or more depth values may be a distance an object is from an image capture device (e.g., a camera of the user's computing device that captured the image 700). As shown in image 700, the first person 702 is three (3) meters from the image capture device and that the object 704 is two (2) meters from the image capture device. The depth information may be used to determine that the object 704 is in the foreground relative to the first person 702.

Though a portion of the representation of the first person 702 is partially obstructed by the object 704, the image 700 may represent an image that includes a less obstructed view of the first person 702 than other images. That is, other images that include a more obstructed view of the first person 702, may not be returned in the search results. Additionally or alternatively, the more obstructed views of the first person 702 may be returned lower in the search results than those that have a less obstructed view.

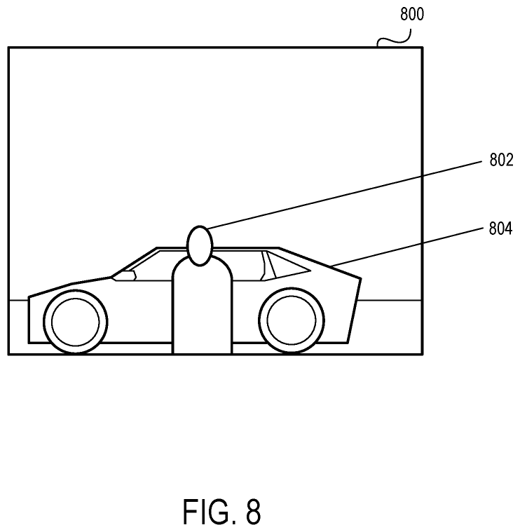

FIG. 8 illustrates an example of an image retrieved based on metadata according to one or more aspects of the disclosure. Any of the operations described as part generating metadata for the image 800 may be performed by any of the computing systems and/or computing devices that are described herein. Further, any of the operations described as part of the generating metadata for the image 800 may be performed by a computing system and/or computing device that includes one or more features and/or capabilities of the computing systems and/or computing devices that are described herein.

The image 800 may show a person standing in front of a car. The tagging techniques described herein may identify a first person 802 and an object 804. The first person 802 may be tagged with a name using the machine-learning techniques described herein and/or facial recognition techniques. For example shown in FIG. 8, the name associated with the first person 802 is “Micky.” The object 804 may be identified, using the machine learning techniques described herein, as a “car” and/or “sports car.” As noted herein, the machine-learning techniques described herein may apply one or more tags (e.g., labels) to an object in an image. Image 800 may be retrieved in response to a search query. For example, a user may enter the search term “MICKY AND SPORTSCAR” into a search tool (e.g., search engine). The search tool may then access a dataset that includes metadata. The search tool may return one or more images that include metadata that corresponds to the search criteria.

Further, the tagged data and/or tagged image data may indicate relative sizes of the one or more objects. The relative sizes may also be compared to any metadata that is associated with the object. For example, if the relative size of the object does not correspond to a size range associated with the metadata, the metadata may be modified and/or analyzed to determine the accuracy of the metadata. For example, if the object 804 was too small relative to the size of the person (“MICKY”), the metadata associated therewith may be updated to reflect that the vehicle is a toy vehicle rather than an actual automobile. Alternatively, the metadata may be updated to indicate that the object 804 is further away from the image capture device. As shown in FIG. 8, the sportscar has a size relative to the person (“MICKY”) that indicates that metadata indicating a sportscar is accurate.

Although the subject matter of the present disclosure has been described in language specific to structural features and/or methodological acts, it is to be understood that the subject matter defined in the claims is not necessarily limited to the specific features or acts described herein. Rather, the specific features and operations described herein are disclosed as example implementations of the claims. The steps of any methods described herein are described as being performed in a particular order for the purposes of discussion. A person having ordinary skill in the art will understand that the steps of any methods discussed herein may be performed in any order and that any of the steps may be modified, omitted, combined, and/or expanded without departing from the scope of the present disclosure. Furthermore, the methods described herein may be performed using any manner of system, device, apparatus, and/or non-transitory computer-readable media.

What is claimed is:

1. A method comprising:
accessing, by a computing device, a plurality of images stored in an image repository, wherein the plurality of images comprises a first image;
detecting, using one or more image processing techniques, a first object in the first image and a second object in the first image;
identifying, using one or more machine-learning models, a first tag associated with the first object and a second tag associated with the second object;
determining, using the one or more machine-learning models, a first depth value associated with the first object and a second depth value associated with the second object;
determining, based on the first depth value and the second depth value, a spatial relationship between the first object and the second object, wherein the spatial relationship comprises locations of the first object and the second object in the first image; and
generating metadata associated with the first image, wherein the metadata indicates the spatial relationship between the first object and the second object.

2. The method of claim 1, wherein the spatial relationship indicates that the first object is in a foreground or a background relative to the second object.

3. The method of claim 1, wherein the spatial relationship indicates one or more proportions of the first image that are occupied by at least one of the first object or the second object.

4. The method of claim 1, further comprising:
excluding a third object from the metadata based on a determination that the third object occupies less than a threshold amount of the first image.

5. The method of claim 1, wherein the spatial relationship indicates that the first object is obstructed by the second object.

6. The method of claim 1, further comprising:
excluding a third object from the metadata based on a determination that the third object is obstructed by greater than a threshold amount.

7. The method of claim 1, wherein the spatial relationship indicates a size of the first object relative to the second object.

8. The method of claim 1, further comprising:
excluding a third object from the metadata based on a determination that the third object is less than a threshold size.

9. The method of claim 1, wherein the one or more image processing techniques comprise at least one of: a scale invariant feature transform (SIFT) technique or a histogram of oriented gradients (HOG) technique.

10. The method of claim 1, wherein the one or more machine-learning models comprise one or more convolutional neural networks.

11. The method of claim 1, wherein the identifying the first tag associated with the first object and the second tag associated with the second object further comprises:
applying a first label to the first object and a second label to the second object.

12. The method of claim 11, further comprising:
determining, based on one or more classifications of the first object and the second object, the first label and the second label; and
writing the first label and the second label to the metadata along with the spatial relationship.

13. The method of claim 12, wherein the one or more classifications comprise at least one of: a person, an animal, a vehicle, a landmark, a foreground, or a background.

14. The method of claim 1, wherein the plurality of images comprises one or more videos.

15. An apparatus comprising:
one or more processors; and
memory storing instructions that, when executed by the one or more processors, cause the apparatus to:
access a plurality of images stored in an image repository, wherein the plurality of images comprises a first image;
detect, using one or more image processing techniques, a first object in the first image and a second object in the first image;
identify, using one or more machine-learning models, a first tag associated with the first object and a second tag associated with the second object;
determine, using the one or more machine-learning models, a first depth value associated with the first object and a second depth value associated with the second object;
determine, based on the first depth value and the second depth value, a spatial relationship between the first object and the second object, wherein the spatial relationship comprises locations of the first object and the second object in the first image; and
generate metadata associated with the first image, wherein the metadata indicates the spatial relationship between the first object and the second object.

16. The apparatus of claim 15, wherein the instructions, when executed by the one or more processors, cause the apparatus to modify image data based at least in part on the metadata, wherein the image data is associated with the first image.

17. The apparatus of claim 16, wherein the modifying the image data comprises adding one or more portions of the metadata to the image data, deleting one or more portions of the metadata associated with the image data, or adjusting one or more portions of the metadata associated with the image data.

18. One or more non-transitory computer readable media comprising instructions that, when executed by at least one processor, cause a computing device to perform operations comprising:
accessing a plurality of images stored in an image repository, wherein the plurality of images comprises a first image;
detecting, using one or more image processing techniques, a first object in the first image and a second object in the first image;
identifying, using one or more machine-learning models, a first tag associated with the first object and a second tag associated with the second object;
determining, using the one or more machine-learning models, a first depth value associated with the first object and a second depth value associated with the second object;
determining, based on the first depth value and the second depth value, a spatial relationship between the first object and the second object, wherein the spatial relationship comprises locations of the first object and the second object in the first image; and
generating metadata associated with the first image, wherein the metadata indicates the spatial relationship between the first object and the second object.

19. The one or more non-transitory computer readable media of claim 18, wherein the first image comprises a plurality of points, and wherein the first depth value and the second depth value are associated with portions of the plurality of points.

20. The one or more non-transitory computer readable media of claim 18, wherein the plurality of images comprises one or more videos.
